(19) United States
(12) Patent Application Publication
(10) Pub. No.: US 2009/0299512 A1
(43) Pub. Date: Dec. 3, 2009

(54) SEMICONDUCTOR MANUFACTURING SYSTEM AND METHOD

(75) Inventors: Junichi TANAKA, Hachioji (JP); Masaru KURIHARA, Kawasaki (JP); Masaru IZAWA, Hino (JP); Hiromasa ARAI, Hitachinaka (JP); Yoichi NAKAHARA, Hitachinaka (JP); Takahiro MARUYAMA, Ashiya (JP); Nobuo FUJIWARA, Kawanishi (JP)

Correspondence Address: MATTINGLY & MALUR, P.C., 1800 DIAGONAL ROAD, SUITE 370, ALEXANDRIA, VA, 22314, US

(73) Assignee: RENESAS TECHNOLOGY CORP., Tokyo (JP)

(21) Appl. No.: 12/469,716

(22) Filed: May 21, 2009

(30) Foreign Application Priority Data
Jun. 2, 2008 (JP) JP2008-144100

(51) Int. Cl. G05B 13/04; G06F 17/00; G06N 5/04

(52) U.S. Cl. 700/104; 700/121; 700/110

(57) ABSTRACT

In the manufacturing system and the manufacturing method of a semiconductor device using a plasma treatment apparatus, a plasma treatment condition is controlled so that a desired shape is obtained after the plasma processing by using a processing shape prediction model for calculating the shape after the plasma processing from the inspection data of a wafer to be treated prior to the treatment and a response surface model for calculating the processing shape depending on a plasma treatment condition. In this configuration, the processing shape prediction model has an adjustable prediction model coefficient, and this prediction model coefficient is automatically calibrated.

### CROSS-REFERENCE TO RELATED APPLICATION

The present application claims priority from Japanese Patent Application No. JP 2008-144100 filed on Jun. 2, 2008, the content of which is hereby incorporated by reference into this application.

### TECHNICAL FIELD OF THE INVENTION

The present invention relates to a manufacturing technique of a semiconductor device, and more particularly, it relates to a technique effectively applied to the manufacturing system and the manufacturing method of a semiconductor device using a plasma treatment apparatus.

### BACKGROUND OF THE INVENTION

According to the studies carried out by the inventors of the present invention, in order to form the desired circuit pattern on a wafer in a manufacturing technique of the semiconductor device, a layer to be processed into a circuit is formed on a wafer by a film forming process, a mask pattern made of a resist material is formed on the layer to be processed by a lithography process, and then the mask pattern is transferred to the layer to be processed by a plasma treatment in a dry etching process. After each of the treatment processes, an inspection process for confirming whether variations in the processing shape by this process are within an allowable range is carried out. The processing shape is usually managed by measuring a processing dimension representing its shape. A film thickness serves as the processing dimension in the film forming process, and a line width, a gate sidewall angle and the like serve as the processing dimensions in the lithography and dry etching processes. Particularly, the processing dimension having an influence on the performance of the semiconductor device is referred to as a CD (Critical Dimension), and for example, the width of a gate electrode serves as the CD in the case of a CMOS (Complementary Metal Oxide Silicon) device. In recent years, in order to maintain the performance of the semiconductor device in which the miniaturization of the circuit pattern has been progressing, it has been required to reduce the variations of the CD due to the processing treatment as far as possible.

For the reduction in the variation of the processing dimension in the plasma etching process, a process control has come to be used actively in recent years. The process control means a technique for making the dimension after processing constant by adjusting a treatment condition for each wafer. While many techniques for stabilizing the processing shape by the process control are conventionally known in the semiconductor manufacture, in the case of the process control of the etching process, two methods of a feed forward control (FF control) and a feedback control (FB control) are mainly used. The technique in which a variation of the structure itself on the wafer brought into the etching process is corrected by the etching process is the feed forward control. In the feed forward control, for example, a shift of a mask pattern dimension from the target value in the lithography process is detected in an inspection process and the shift is corrected in the next etching process. Further, the time-dependent change that the performance of the plasma etching apparatus changes when a wafer treatment is repeated, often becomes a problem, and the technique in which this time-dependent change is detected by the inspection process after the etching and the treatment condition of the etching process is corrected is the feedback control.

For example, Japanese Patent Application Laid-Open Publication No. 2007-88485 (Patent Document 1) discloses a method of making the CD constant by combining the feed forward control and the feedback control in the lithography process for forming a gate electrode pattern. In the method of the patent document 1, a line width after the treatment is predicted prior to the treatment by using a CD prediction model formula using a wafer carrying time, a temperature and an atmospheric pressure inside the apparatus and the like measured inside the lithography apparatus, and a shift amount between this prediction value and the target value of the line width is calculated. Next, the feed forward control for determining a correction amount of the treatment parameter by using a RSM (Response Surface Model) showing a relationship between a treatment parameter and the CD is performed. Thereafter, the feedback control for detecting the shift of control by using an inspection value of the process result and then correcting the RSM is performed. A method of combining the feed forward control and the feedback control by using the CD prediction model and RSM is a technique used widely. In the patent document 1, the above-described control technique is applied to a heat treatment process and a coating process in the lithography apparatus. Further, Japanese Patent Application Laid-Open Publication No. 2006-287232 (Patent Document 2) discloses a technique, in which an optical resist shape inspection apparatus is incorporated in the lithography apparatus and the resist shape is applied as an argument of the CD prediction model formula, thereby improving the control accuracy.

In the lithography process described above, a focus and an exposure at the exposing time are often taken as the control parameters. In order to prepare the RSM using these focus and exposure, a FEM (Focus Exposure Matrix) intentionally varying the focus and the exposure for each shot of a piece of water so as to perform the exposure in a matrix pattern can be used. A method of determining the RSM by using this FEM method is disclosed in Japanese Patent Application Laid-Open Publication No. 2008-10862 (Patent Document 3). Further, a method of determining the optimum focus and exposure in consideration of the statistical distribution of the CD obtained after the treatment by employing the response surface model using the focus and the exposure is also disclosed in Japanese Patent Application Publication (kohyo) No. 2006-512758 (Patent Document 4).

On the other hand, an example where the feed forward control and the feedback control using the RSM are applied to the etching process performed following the lithography process in the forming process of a gate electrode is disclosed in Japanese Patent Application Laid-Open Publication No. 2007-281248 and Japanese Patent Application Laid-Open Publication No. 2007-266335 (Patent Documents 5 and 6). The patent documents 5 and 6 disclose a method of performing the feed forward control of the etching process by using the CD prediction model formula between multiple processes employing the inspection values measured after the various treatment processes prior to the etching process.

In the patent documents 1 to 6 enumerated so far, a model coefficient of the RSM used for the calculation of the control parameter is automatically adjusted by the feedback control. On the other hand, they describe that the model coefficient of the CD prediction model formula is determined in advance by the experiment and the like. A method of determining the model coefficient of the CD prediction model formula in the lithography process is disclosed in the patent document 3, and a method of determining the model coefficient of the CD prediction model formula by using an experimental design method in the etching process is disclosed in the patent documents 5 and 6.

Further, an example of using an autocorrelation model that predicts the CD from the past time-series data of the CD itself instead of other measurement values is disclosed in Japanese Patent Application Laid-Open Publication No. 2002-343726 (Patent Document 7). The embodiment of the patent document 7 discloses a technique of fixedly determining the coefficient of an ARMA (autocorrelation moving average model) model formula and a technique of dynamically determining the same in a method of predicting the next CD from the time-series data of the CD by using the ARMA.

### SUMMARY OF THE INVENTION

Incidentally, as a result of the studies carried out by the inventors of the present invention regarding the manufacturing technique of the semiconductor device as described above, the following has been clarified. In the methods disclosed in the patent documents 1 to 6, the model coefficient of the processing shape prediction model is determined from the experimental result before starting the production. Particularly, when the model coefficient of the model between the multiple processes is determined from an experiment using an experimental design method as disclosed in the patent documents 5 and 6, considerable amount of time and effort are required because it is necessary to perform experiments in which the treatment conditions of a plurality of other processes are changed. When a workload for determining the model coefficient is heavy in the case where a process control is started up as described above, the work becomes complicated when applying the process control to a plurality of products in the manufacturing line for producing a plurality of products, so that the practicality is lowered. Consequently, an object of the present invention is to simplify the work for determining the model coefficient of the processing shape prediction model by the experiment and the like at the time of starting up the production.

Further, even when the process control is once applied to start the production, a state of the manufacturing line varies each day. In each treatment process, various changes occur in such a manner that parts constituting the apparatus are replaced at the maintenance time of the manufacturing apparatus, the lot of raw materials used for the manufacture is changed, and the manufacturing procedure is changed. After these changes, it is confirmed that no variance occurs in the inspection value of the processing treatment in this process by the inspection process performed following this process. However, the inspection spot of each treatment process is selected from the portion necessary and easily measurable to maintain the performance of the manufacturing apparatus of this process, and in many cases, it is not managed in the light of whether or not the subsequent processes are affected. Further, the changes of the apparatus state and the procedure are also likely to occur in the inspection apparatus. It has become clear that even if the influence given to a state of the wafer after the processing by such changes is not detected by the inspection data of this process, such an influence is detected as a change of the processing shape after the subsequent plasma treatment. In other words, the model coefficient of the processing shape prediction model changes by the change of the production state not found by the inspection data.

It is an extremely difficult work to properly review the prediction model coefficient under the situation where the prediction model coefficient is not easily seized by the inspection alone after each process in the manufacturing line varying each day. Although the patent document 6 describes that “the coefficient A is derived from the experiment or the statistical work of a large amount of wafers at the time of mass production”, neither the variation of the prediction model coefficient nor the specific method of the statistical work is disclosed. Further, although the patent document 7 discloses a method of determining the prediction model coefficient by the autocorrelation model from the time-series data of the CD, the prediction model in this case is a future prediction model having the time-series data itself of the CD as a variable (equivalent to the prediction model of stock prices), and it is extremely low in predicting accuracy due to its characteristic and is not suitable for the application to the highly accurate process control. The model like this predicts the tendency of the future CD variation from the variation of the CD itself when the cause of the variation of the CD is unknown, and it is, therefore, not much appropriate to apply such a model to the process control. Even the patent document 7 does not disclose a method of determining the prediction model coefficient for predicting the CD from the inspection data of the multiple processes. Consequently, another object of the present invention is to provide a method in which the prediction model coefficient is taken as a variable and this coefficient is automatically renewed without taking any work such as the experiment during the production.

The above and other objects and novel characteristics of the present invention will be apparent from the description of this specification and the accompanying drawings.

The typical ones of the inventions disclosed in this application will be briefly described as follows.

That is, the outline of the representative aspect of the present invention relates to the manufacturing system and the manufacturing method of a semiconductor device using the plasma treatment apparatus, wherein the prediction model coefficient of the processing shape prediction model is taken as a variable, and the prediction model coefficient is automatically optimized by using the inspection data of the wafer, and it has the following features.

(1) In the configuration where a plasma treatment condition is controlled so that a desired shape can be obtained after the plasma processing by using the processing shape prediction model for calculating the shape after the plasma processing prior to the treatment from the inspection data of the wafer to be treated and the response surface model for calculating the processing shape depending on the plasma treatment condition, this processing shape prediction model has an adjustable prediction model coefficient and automatically calibrates this prediction model coefficient.

(2) The optimum value of the prediction model coefficient is determined by using a control shift amount evaluation function for evaluating a shift amount from the target value of the process-controlled result.

(3) The control shift amount evaluation function taking into consideration the feedback correction amount of the response surface model is used.

(4) Instead of determining the prediction model coefficient used for the process control of the plasma treatment process by the experiment, a simple value is given as an initial value of the prediction model coefficient, and the prediction model coefficient is automatically optimized while continuing the production of the semiconductor device.

(5) The prediction model coefficient used in another semiconductor device is given as an initial value of the prediction model coefficient of a certain semiconductor device, and the prediction model coefficient is automatically optimized while continuing the production of the semiconductor device.

(6) The production of a semiconductor device is started in a state where there is no process control of the plasma treatment process, and the prediction model coefficient is automatically optimized when specific conditions are satisfied, and then the process control of the plasma treatment process is started.

The effects obtained by typical embodiments of the inventions disclosed in this application will be briefly described below.

That is, the effect obtained by the typical aspect of the present invention is that the prediction model coefficient is not determined by the experiment and the like and the process control can be started in application on the production. Further, since the model coefficient of the processing shape prediction model is automatically adjusted when a state of the production line varies, it is possible to perform the process control always in an optimum state without taking much time for the calibration experiment and the like.

### BRIEF DESCRIPTION OF THE DRAWINGS

FIG. 1 is a view relating to the first embodiment of the present invention, and is a block diagram showing the manufacturing system of a semiconductor device;

FIG. 2 is a view relating to the first embodiment of the present invention, and is a schematic view showing an outline of the flow of the treatment process of the semiconductor device and a shape of the device on the wafer surface after each process;

FIG. 3 is a view relating to the first embodiment of the present invention, and is a view showing a flow of the automatic optimization of the processing shape prediction model coefficient in the plasma treatment process to which the process control is applied;

FIG. 4 is a view relating to the second embodiment of the present invention, and is a view showing a flow of the automatic optimization of a prediction model coefficient in the plasma treatment process to which the process control including the feedback control is applied;

FIG. 5 is a view relating to the third embodiment of the present invention, and is a flowchart showing a flow of applying a process control to a plasma treatment process at the time of starting up the production of a certain semiconductor device A;

FIG. 6 is a view relating to the third embodiment of the present invention, and is a graph showing an example in which a prediction model coefficient b₄ is optimized by an actual production data;

FIG. 7 is a view relating to the third embodiment of the present invention, and is a graph showing an example in which a prediction model coefficient b₅ is optimized by an actual production data;

FIG. 8 is a view relating to the third embodiment of the present invention, and is a graph showing an example in which an EWMA coefficient γ is optimized by an actual production data;

FIG. 9 is a view relating to the fourth embodiment of the present invention, and is a flowchart showing a flow of applying a process control to a plasma treatment process at the time of starting up the production of a semiconductor device B different from a certain semiconductor device A; and

FIG. 10 is a view relating to the fifth embodiment of the present invention, and is a flowchart showing a flow in which a process control is not applied to a plasma treatment process at the time of starting up the production of a semiconductor device and the process control is applied after the start of the production.

### DESCRIPTION OF THE PREFERRED EMBODIMENTS

Hereinafter, embodiments of the present invention will be described in detail with reference to the accompanying drawings. Note that components having the same function are denoted by the same reference numbers throughout the drawings for describing the embodiments, and the repetitive description thereof will be omitted.

### First Embodiment

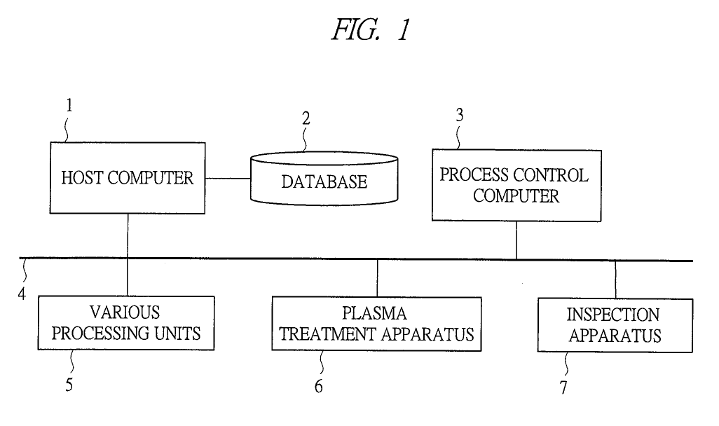

The manufacturing system and the manufacturing method of a semiconductor device according to the first embodiment of the present invention will be described with reference to FIGS. 1 to 3.

FIG. 1 is a view relating to the first embodiment of the present invention, and is a block diagram showing the manufacturing system of a semiconductor device.

The manufacturing system of the semiconductor device is constituted of a host computer 1, a database 2, a process control computer 3, a production information backbone LAN (Local Area Network) 4, various processing units 5, a plasma treatment apparatus 6, an inspection apparatus 7, and the like.

The various processing units 5, the plasma treatment apparatus 6, and the inspection apparatus 7 are connected to the production information backbone LAN 4. The host computer 1 sends information on treatment conditions and the like to the various processing units 5 and the plasma treatment apparatus 6 through the production information backbone LAN 4. Further, the inspection apparatus 7 sends the inspection result to the host computer 1 through the production information backbone LAN 4, and the host computer 1 stores the received inspection data in the database 2.

The process control computer 3 functions as a control unit for controlling a treatment condition of the plasma treatment apparatus 6, and is provided with a processing shape prediction model for calculating a shape after the plasma treatment from the inspection data of a wafer prior to the treatment, a response surface model for calculating the processing shape depending on a plasma treatment condition, and a program for realizing prediction model coefficient optimization which automatically calibrates the prediction model coefficient showing a degree of the influence of each variable used for the processing shape prediction model. While optimizing the prediction model coefficient by this program, the treatment condition is controlled by using the processing shape prediction model and the response surface model so that the desired shape can be obtained after the plasma treatment.

The host computer 1 takes out and sends the information necessary for the process control computer 3 from the database 2 before the wafer treatment, and the process control computer 3 calculates a correction amount of the treatment condition of the plasma treatment apparatus 6 and sends back it to the host computer 1. The host computer 1 sends the received correction amount to the plasma treatment apparatus 6, and the wafer is subjected to the treatment under an appropriate treatment condition in the plasma treatment apparatus 6.

Note that the database 2 may be connected to the process control computer 3 or may be directly connected to the production information backbone LAN 4. Further, the database 2 may be incorporated and managed in the host computer 1 and the like of the production line or may be managed as a part of the process control computer 3. Also, when the data transfer amount increases, a data transmission LAN other than the backbone LAN can be used according to the purpose. In addition, the process control computer 3 may be directly connected to the host computer 1 or may be a part of the host computer 1.

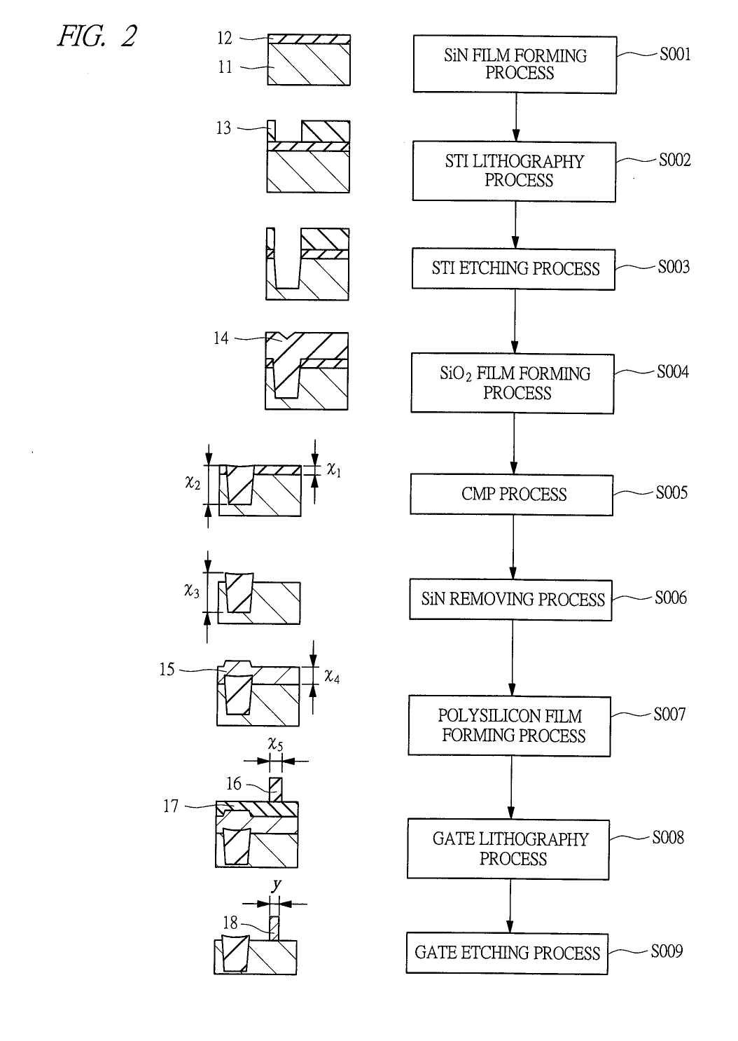

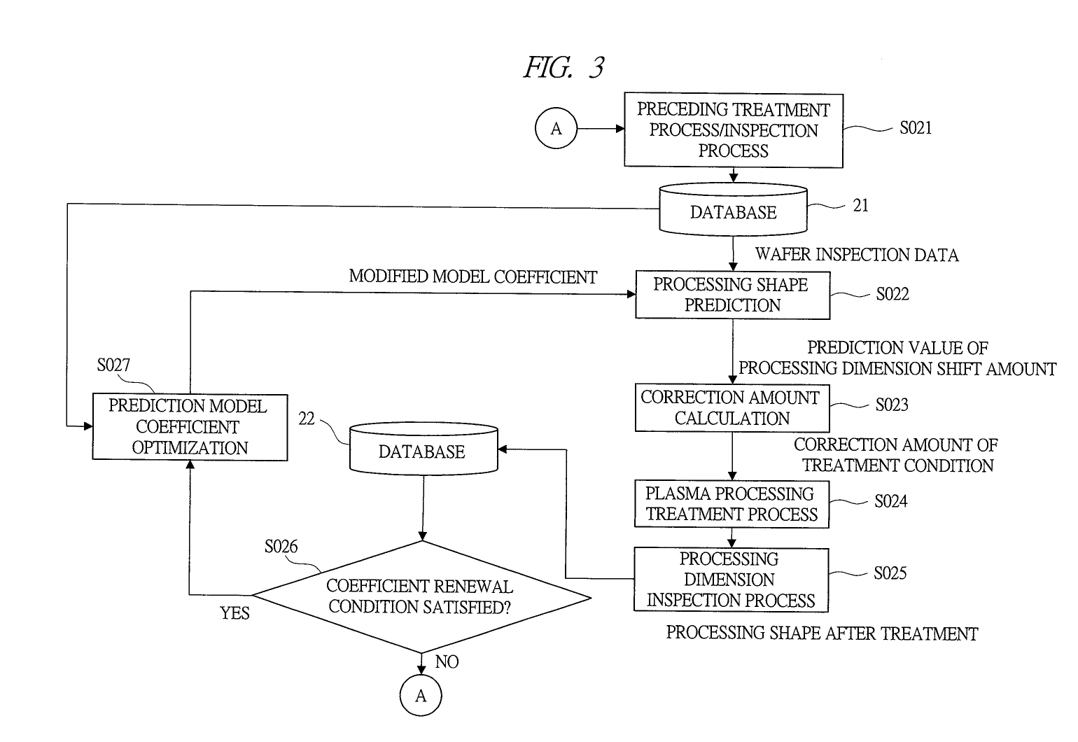

FIGS. 2 and 3 are views relating to the first embodiment of the present invention. FIG. 2 is a schematic view showing an outline of the flow of the treatment process of the semiconductor device and a shape of the device on the wafer surface after each process, and FIG. 3 is a view showing a flow of the automatic optimization of the processing shape prediction model coefficient in the plasma treatment process to which the process control is applied.

In FIG. 2, a CMOS transistor is taken as an example of the semiconductor device, and an outline of the processes up to the formation of a gate electrode on the wafer is shown. The gate electrode is an important circuit part determining the performance of the CMOS transistor, and a width (y) of the gate electrode becomes a CD. The first embodiment shows a process control method for keeping the value of y which is the CD constant.

First, a SiN film (silicon nitride film) 12 is formed on a silicon wafer 11 in a SiN film forming process S001, and a resist mask 13 having a pattern of an element isolation (STI: Shallow Trench Isolation) is formed on the SiN film in a STI lithography process S002. By the plasma etching of the next etching process S003, a mask pattern is transferred to the SiN film 12 and the silicon wafer 11. After the resist mask and etching residues are removed by the ashing process and cleaning process (not shown), a SiO₂ film (silicon oxide film) 14 is formed for the purpose of element isolation in a SiO₂ film forming process S004. In the next CMP (Chemical Mechanical Polishing) process S005, an unnecessary SiO₂ film is removed with using the SiN film 12 as a stopper layer, so that the surface is planarized. Since the thickness (x₁) of the SiN film and the thickness (x₂) of the SiO₂ film left at this time affect the subsequent etching process, these film thicknesses are measured and stored in the database 2 and the like.

In the next SiN removing process S006, the SiN film is removed by wet etching and the like, and the thickness (x₃) of the remaining SiO₂ film is also measured and stored as a variable affecting the subsequent etching process. Further, after going through the forming process of a gate oxide film (not shown), a polysilicon film 15 constituting the gate electrode is formed in a polysilicon film forming process S007. The thickness (x₄) of this polysilicon film is also stored as a factor affecting the subsequent etching. Next, after going through an implanting process and the like (not shown), a BARC (Bottom Anti-Reflection Coating) film 17 and a resist mask 16 having a gate electrode pattern are formed by a gate lithography process S008. The width (X₅) of the resist mask is the most important variable determining the width (y) of a gate electrode 18 formed in the next plasma treatment process, that is, a gate etching process S009, and is stored in the database 2 and the like.

Next, in the gate etching process S009, a process control as shown in FIG. 3 is executed. In FIG. 3, a database 21 and a database 22 correspond to the database 2 of FIG. 1, and a treatment process/inspection process S021 prior to the plasma treatment process is executed by the various processing units 5, a plasma processing treatment process S024 is executed by the plasma treatment apparatus 6, and a processing dimension inspection process S025 is executed by the inspection apparatus 7, respectively. Other processing shape prediction step S022, correction amount calculation step S023, coefficient renewal condition determining step S026, and prediction model coefficient optimization step S027 are executed by the process control computer 3 through the host computer 1.

In FIG. 3, the treatment processes S001 to S008 of FIG. 2 are collectively shown as the treatment process/inspection process S021 preceding the plasma treatment process. Inspection data such as the processing dimensions (x₁ to x₅ and the like) obtained during this treatment process/inspection process S021 is sent to the database 21 and stored therein. The inspection is carried out for each wafer in some cases or carried out per a lot unit including a plurality of wafers in other cases, and in this case, several wafers are extracted from the lot to carry out the inspection. Since a unit of the process control is a wafer unit or a lot unit in the gate etching process S009 by the plasma treatment, the database 21 must be configured so that a set of the inspection data corresponding to the wafer or the lot to be controlled can be easily extracted. When the process of the wafer or the lot is started in the plasma treatment process, first, the processing shape after the treatment is predicted in the processing shape prediction step S022. When a prediction value of the gate dimension in the case where the n-th wafer is treated under the treatment condition serving as a reference is taken as yₑ⁽ⁿ⁾, the processing shape prediction model is expressed by, for example, the following formula 1.

yₑ⁽ⁿ⁾=y₀+b₁(x₁⁽ⁿ⁾−X₁)+b₂(x₂⁽ⁿ⁾−X₂)+b₃(x₃⁽ⁿ⁾−X₃)+b₄(x₄⁽ⁿ⁾−X₄)+b₅(x₅⁽ⁿ⁾−X₅) [Formula 1]

Here, y₀ is a target value of the processing dimension, b₁, b₂, b₃, b₄ and b₅ are model coefficients, respectively, and xᵢ⁽ⁿ⁾ is an inspection value of the processing dimension in a process i of the n-th wafer, and Xᵢ is a target value of the processing dimension of the process i. From the formula 1, a shift from the target value of the processing dimension predicted before the etching treatment can be calculated as yₑ^{(n)-y}₀. Next, a shift amount of this processing dimension is sent to a correction amount calculation step S023. In the correction amount calculation step S023, a correction amount of the treatment condition necessary to make the processing dimension be a target value is calculated by using the response surface model. Although the treatment conditions to be controlled may be as many as desired, they are often expressed as an M-order polynomial of a control variable. M is an optional integer. For example, when the treatment condition to be controlled is only one and it can be expressed by a first-order polynomial, the response surface model can be expressed as the following formula 2.

y=c₀+c₁p [Formula 2]

In the formula 2, c₀ and c₁ are the model coefficients of the response surface model, and p is a treatment condition to be controlled. Now, since the target value of y is y₀ and it is predicted by the formula 1 which is the processing dimension prediction model that the processing dimension becomes larger than the target value by yₑ⁽ⁿ⁾−y₀ when the n-th wafer is treated by the treatment condition serving as a reference, in order to finally obtain the target value of the processing dimension of y₀, a value smaller than y₀ by yₑ⁽ⁿ⁾−y₀ should be taken as a target value of the processing dimension of the n-th wafer. Thus, the target value of the n-th wafer becomes 2y₀−yₑ⁽ⁿ⁾. Consequently, in the correction amount calculation step S023, a desired treatment condition p⁽ⁿ⁾ of the n-th wafer can be determined by the following formula 3 by using the response surface model of the formula 2.

p(n)=(2y₀−yₑ⁽ⁿ⁾−c₀)/c₁ [Formula 3]

The desired treatment condition of the n-th wafer calculated by the formula 3 is sent to the plasma treatment apparatus, and the next plasma processing treatment process S024 is executed. This is the feed forward control of the plasma treatment process. The processing dimension (y⁽ⁿ⁾) actually obtained after the processing treatment is measured by a processing dimension inspection process S025. The measured processing dimension value is stored in the database 22.

When the production of the semiconductor device is continued by the plasma treatment using the process control as shown in FIG. 3 according to the first embodiment, various inspection data (x₁⁽ⁿ⁾ to x₅⁽ⁿ⁾) of the wafer are accumulated in the database 21, and the processing dimension data y⁽ⁿ⁾ actually measured are accumulated in the database 22. Although FIG. 3 shows an example in which the database 21 and the database 22 are separated, the execution of the present invention is not affected even if all the data is accumulated in one database or the database is further segmentalized, in other words, no matter which type of the database is used.

With the change of the production line, the optimum values of the prediction model coefficients b₁ to b₅ of the formula 1 also change, and therefore, the prediction model coefficient is automatically corrected in the prediction model coefficient optimization step S027 when a coefficient renewal condition is satisfied in a coefficient renewal condition determination step S026. This is the main feature of the present invention. This coefficient renewal condition may be set for each wafer treatment or for each lot treatment. Alternatively, by setting the coefficient renewal condition which is determined by such events as the apparatus maintenance, the material change and the procedure change of the manufacturing apparatus used in the other treatment process/inspection process S021 prior to the plasma treatment process, the automatic renewal of the prediction model coefficient may be performed when the coefficient renewal condition is satisfied in the coefficient renewal condition determination step S026.

For example, the automatic renewal in the prediction model coefficient optimization step S027 can be performed by the following procedure. For the automatic renewal, a control shift amount evaluation function E showing the control shift amount is used. For example, the control shift amount evaluation function E is expressed as the following formula 4.

$$E ( {b}_{1} , {b}_{2} , {b}_{3} , {b}_{4} , {b}_{5} ) = {\sum }_{n} {( 2 {y}_{0} - {y}_{e}^{( n )} - {y}^{( n )} )}^{2} \qquad [ Formula 4 ]$$

It can be understood from the formula 1 that the control shift amount evaluation function E defined by the formula 4 is the function of the prediction model coefficients b₁ to b₅. When the prediction model coefficients b₁ to b₅ are determined so that the value of the control shift amount evaluation function E of the formula 4 becomes the minimum value, they become the optimum prediction model coefficients. Any mathematical technique can be used for solving this minimization problem, and those frequently used are the Newton Method, the modified Newton Method, the Marcato Method and the like.

As described above, according to the manufacturing system and the manufacturing method of the semiconductor device of the first embodiment, in the configuration where the plasma treatment condition is controlled by using the processing shape prediction model of the formula 1 and the response surface model of the formula 2, the model coefficients b₁ to b₅ of the processing shape prediction model are automatically calibrated, so that the process control can be started in application on the production without determining these model coefficients by the experiment and the like. Further, since the model coefficient of the processing shape prediction model is automatically adjusted when a state of the production line varies, the process control can be performed always in an optimum state without taking much time for the calibration experiment and the like.

### Second Embodiment

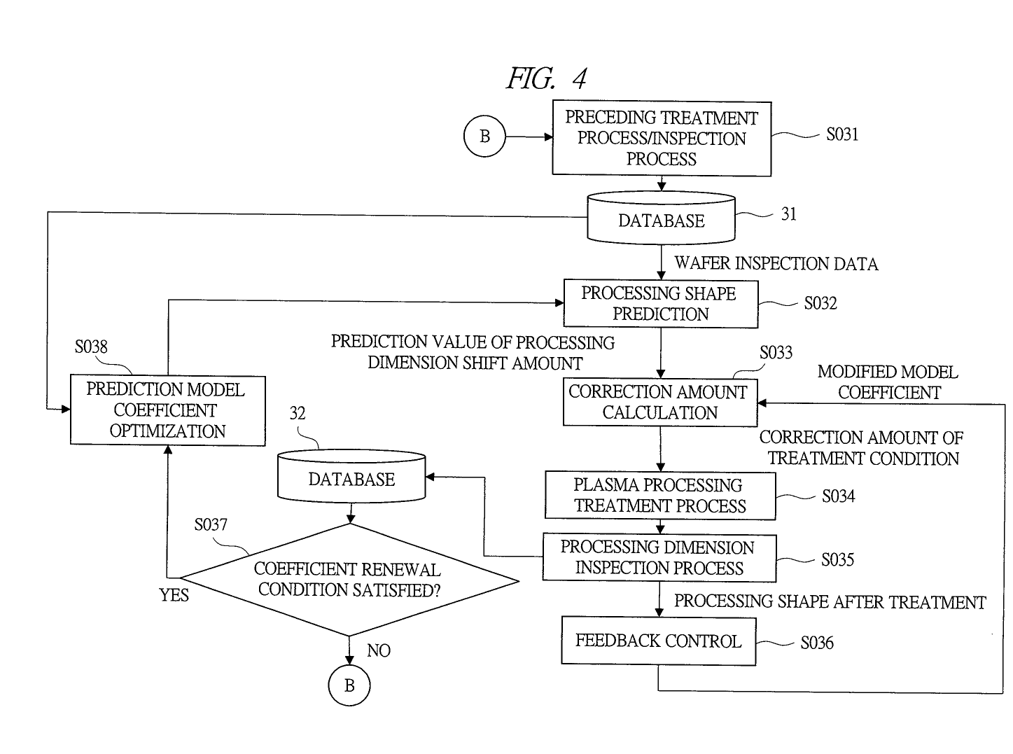

The manufacturing system and the manufacturing method of a semiconductor device according to the second embodiment of the present invention will be described with reference to FIG. 4. The manufacturing system of the semiconductor device according to the second embodiment of the present invention is the same as FIG. 1 of the first embodiment.

FIG. 4 is a view relating to the second embodiment of the present invention, and is a view showing a flow of the automatic optimization of a prediction model coefficient in the plasma treatment process to which the process control including the feedback control is applied.

The outline of the flow of the process of FIG. 4 is almost the same as FIG. 3 of the first embodiment. More specifically, each step of a treatment process/inspection process S031 prior to a plasma treatment process, a processing shape prediction step S032, a correction amount calculation step S033, a plasma processing treatment process S034, a processing dimension inspection process S035, a coefficient renewal condition determination step S037, and a prediction model coefficient optimization step S038 as well as a database 31 and a database 32 are the same as the first embodiment, and a feedback control step S036 is added.

Even when a feed forward control is performed by using a processing shape prediction model, in reality, the actual processing dimension (y⁽ⁿ⁾) measured in the processing dimension inspection process S035 rarely completely conforms to the target value y₀. When the feedback control step S036 is performed in order to correct the influence of the time-dependent change of the plasma treatment apparatus, the model coefficient of the response surface model is modified by using the formula 2 and the obtained y⁽ⁿ⁾. In the case of the feedback control of the response surface model of the formula 2, it is generally practiced that either of the model coefficient c₀ or c₁ is corrected so as to be consistent. For example, when the model coefficient c₀ is controlled, since the c₀ becomes a variable, the c₀ used in the calculation before treating the n-th wafer is described as a cₒ⁽ⁿ⁾. Assuming that the model coefficient c₀ adjusted to be consistent with the n-th wafer is used in the next treatment of the n+1-th wafer, the calculation as the following formula 5 can be made.

c₀⁽ⁿ⁺¹⁾=y⁽ⁿ⁾−c₁p⁽ⁿ⁾ [Formula 5]

In the method of the formula 5, since the value of the model coefficient c₀ tends to be frequently unsteady due to the random variations of the processing treatment, an EWMA (Exponentially Weighted Moving Average) like the following formula 6 is used in many cases.

c₀⁽ⁿ⁺¹⁾=(1−γ)c₀⁽ⁿ⁾+γ(y⁽ⁿ⁾−c₁p⁽ⁿ⁾) [Formula 6]

In the formula 6, γ is a relaxation coefficient referred to as an EWMA coefficient. More specifically, at the time of treating the n+1-th wafer, the c₀⁽ⁿ⁺¹⁾ renewed by the formula 5 or the formula 6 is used in place of the c₀ of the formula 3 to calculate the correction amount of the treatment condition, whereby the feedback control can be performed. As a result, if the c₀ at the treatment condition serving as a reference is expressed as c₀₀, the correction amount Δc₀⁽ⁿ⁾ by the feedback control at the time of treating the n-th wafer can be calculated by the following formula 7.

Δc₀⁽ⁿ⁾=c₀⁽ⁿ⁾−c₀₀ [Formula 7]

A control shift amount evaluation function E_{FB} used in the prediction model coefficient optimization step S038 of FIG. 4 is defined as, for example, the following formula 8 in consideration of the feedback control step S036.

$${E}_{FB} ( {b}_{1} , {b}_{2} , {b}_{3} , {b}_{4} , {b}_{5} , γ ) = {\sum }_{n} {( \begin{matrix}2 {y}_{0} - {y}_{e}^{( n )} - \\ Δ {c}_{0}^{( n )} - {y}^{( n )}\end{matrix} )}^{2} \qquad [ Formula 8 ]$$

When the prediction model coefficients b₁ to b₅ and γ are determined so that the value of the control shift amount evaluation function E_{FB} of the formula 8 becomes the minimum value, they become the optimum prediction model coefficients. In the conventional feedback control, the process control is carried out assuming that the value of the EWMA coefficient γ is in the range of 0<γ<1, but the value of the EWMA coefficient γ can be also automatically corrected to the optimum value by calculation by using the method of the second embodiment.

As described above, according to the manufacturing system and the manufacturing method of the semiconductor device of the second embodiment, the same effect as the first embodiment can be obtained, and at the same time, since the optimum prediction model coefficient can be determined in the control shift amount evaluation function of the formula 8, the process control including the feedback control can be performed in a state of being automatically corrected to the optimum value.

### Third Embodiment

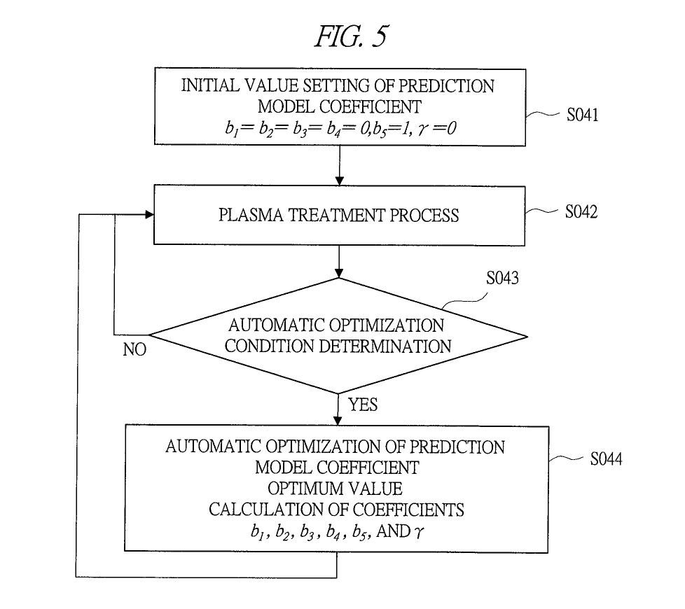

The manufacturing system and the manufacturing method of a semiconductor device according to the third embodiment of the present invention will be described with reference to FIGS. 5 to 8. The manufacturing system of the semiconductor device according to the third embodiment of the present invention is the same as FIG. 1 of the first embodiment.

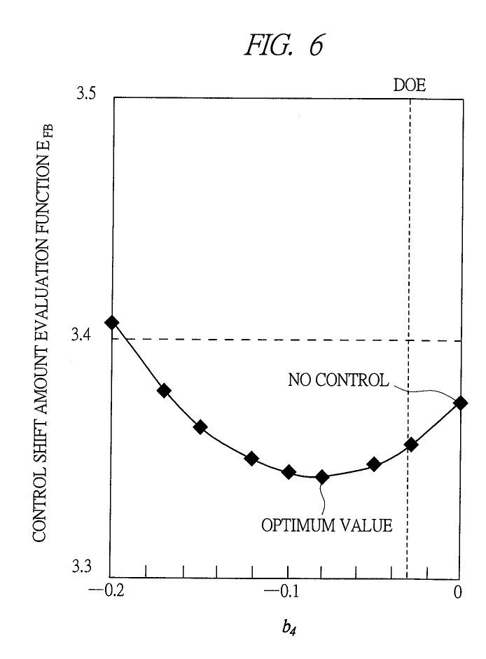

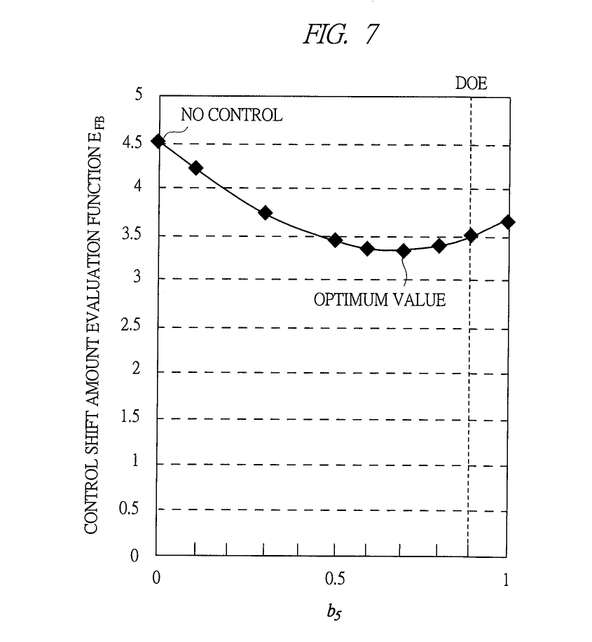

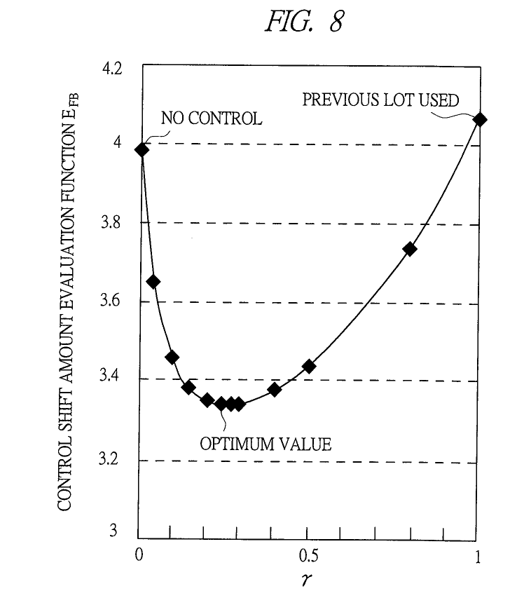

FIGS. 5 to 8 are views relating to the third embodiment of the present invention. FIG. 5 is a flowchart showing a flow of applying a process control to a plasma treatment process at the time of starting up the production of a certain semiconductor device A, FIGS. 6 and 7 are graphs each showing an example of optimizing a prediction model coefficient by the actual production data, and FIG. 8 is a graph showing an example of optimizing an EWMA coefficient γ by the actual production data.

The third embodiment of FIG. 5 shows a method of applying a process control without calculating the prediction model coefficient by the experiment and the like at the time of starting the manufacture of the product of a certain semiconductor device A. The processes prior to the plasma treatment process sometimes include a process having an extremely strong influence on the plasma treatment process. In the case of the process flow of FIG. 2, the gate lithography process S008 gives a strong influence on the gate etching process which is the subsequent plasma treatment process. In other words, the resist mask dimension x₅ obtained as a result of this gate lithography process has a strong relation with the gate dimension y. In such a case, the process control can be started on the assumption that the coefficients of the prediction model formula of the formula 1 are like those shown in the following formula 9 in a prediction model coefficient initial value setting step S041.

b₁=b₂=b₃=b₄=γ=0, b₅₌1 [Formula 9]

More specifically, the prediction model coefficients (b₁ to b₅) and the EWMA coefficient (γ) performing the feed forward control by a term having a large influence but not performing the feed forward control and the feedback control by other terms having a small influence are set as initial values. A plasma treatment process S042 of the semiconductor device A, for example, the etching process control is performed by using the initial value of the formula 9, and when it is determined that a condition capable of executing the automatic optimization of the prediction model coefficient is satisfied in an automatic optimization condition determination step S043, an automatic optimization step S044 of the prediction model coefficient is executed. According to the third embodiment shown in FIG. 5, the optimization can be started from a simple initial value like the formula 9 without performing the experiment and the like at the time of starting up the process control, and then, the initial value can be gradually optimized to the optimum prediction model coefficient. In particular, such a method has an advantage that when plural kinds of semiconductor devices are manufactured in the production line, the management thereof is facilitated.

FIG. 6 shows a case of the prediction model coefficient b₄ of a polysilicon film thickness as an example where the prediction model coefficient is optimized in accordance with the procedure of FIG. 5. In FIG. 6, since a control shift amount evaluation function E_{FB} becomes the minimum value when the value of b₄ is 0.09, the optimum value of b₄ is defined as 0.09. The value described as DOE (Design Of Experiments) in the figure is a value of b₄ determined by an experimental design method in another occasion, and when b₄ is the value of the DOE, a control shift amount is somewhat large. FIG. 7 is an example in which the optimization of the prediction model coefficient is performed in the same manner as FIG. 6, and shows an example of the optimization of the prediction model coefficient b₅ of the resist mask dimension. The value is optimum when the prediction model coefficient b₅ is 0.7. When the value of the prediction model coefficient b₅ is 1, it means that the variance of the resist mask dimension x₅ is directly transferred as the variance of the processing dimension y after the etching, and the value of b₅ of 0.9 determined by the DOE means that the resist mask dimension is approximately transferred to the processing dimension after the etching. Next, an example where the EWMA coefficient γ used for the feedback is optimized is shown in FIG. 8. Since the control shift amount evaluation function E_{FB} becomes the minimum value when γ is 0.25, the optimum value of γ is 0.25. When γ is 0, the feedback control does not work, and when γ is set to 1, the feedback control becomes equivalent to that using the formula 5 in which the previous treatment result of the wafer or lot is used as it is.

In the description above, the value at which the control shift amount evaluation function becomes the minimum value is used as the optimum value of the prediction model coefficient, but the set value of the prediction model coefficient may have a certain width in the vicinity of the minimum value. More specifically, as is evident from FIGS. 5, 6 and 7, when the prediction model coefficient is present in the vicinity of the optimum value, the value of the control shift amount evaluation function does not change so much. In other words, even if the prediction model coefficient is slightly changed in the vicinity of the optimum value, the obtained improvement effect is not much different. Hence, if the frequent change of the prediction model coefficient is not wanted, such a method may be adopted that a certain allowable range, for example, an allowable range of the minimum value plus 5% is provided for the control shift amount evaluation function, and the prediction model coefficient is not changed when the prediction model coefficient exists within a range corresponding thereto.

As described above, according to the manufacturing system and the manufacturing method of the semiconductor device of the third embodiment, when the process control is applied to the plasma treatment process at the time of starting up the production of a certain semiconductor device A, the same effects as the first and second embodiments can be obtained.

### Fourth Embodiment

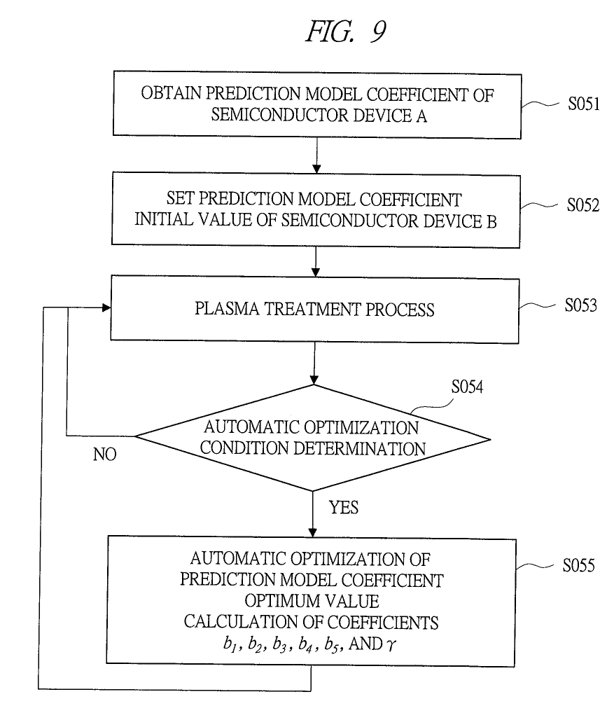

The manufacturing system and the manufacturing method of a semiconductor device according to the fourth embodiment of the present invention will be described with reference to FIG. 9. The manufacturing system of the semiconductor device according to the fourth embodiment of the present invention is the same as FIG. 1 of the first embodiment.

FIG. 9 is a view relating to the fourth embodiment of the present invention, and is a flowchart showing a flow of applying a process control to a plasma treatment process at the time of starting up the production of a semiconductor device B different from the certain semiconductor device A.

In FIG. 9, at the time of starting up a process control of the plasma treatment process of the semiconductor device B, the prediction model coefficient (b₁ to b₅ also including γ) of the semiconductor device A to which the process control has been already applied is obtained (S051), and this prediction model coefficient is set as an initial value of the prediction model coefficient of the semiconductor device B (S052). The semiconductor device B is produced by using the process control (plasma treatment process S053) using this initial value, and when it is determined that a condition for executing the automatic optimization of the prediction model coefficient is satisfied in an automatic optimization condition determination step S054, the automatic optimization of the prediction model coefficient is executed (S055). The technique of FIG. 9 is particularly effective when the circuit patterns of the semiconductor devices A and B are similar to each other, that is, when the semiconductor devices A and B are the products of the same series. This is because the prediction mode coefficients of the semiconductor devices A and B have the similar values.

As described above, according to the manufacturing system and the manufacturing method of the semiconductor device of the fourth embodiment, when the process control is applied to the plasma treatment process at the time of starting up the production of the semiconductor device B different from the certain semiconductor device A, the same effects as the first and second embodiment can be obtained.

### Fifth Embodiment

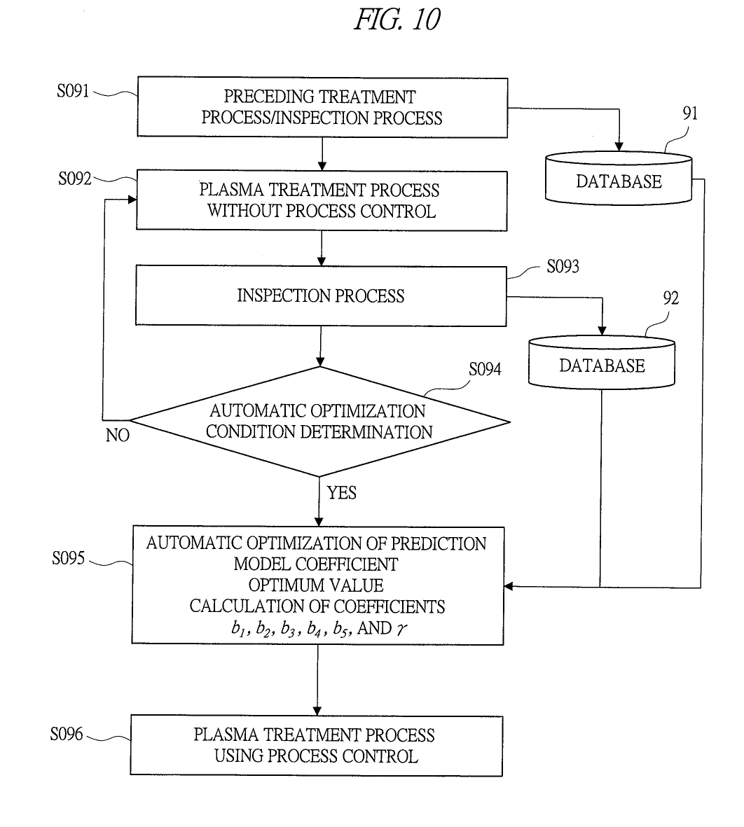

The manufacturing system and the manufacturing method of a semiconductor device according to the fifth embodiment of the present invention will be described with reference to FIG. 10. The manufacturing system of the semiconductor device according to the fifth embodiment of the present invention is the same as FIG. 1 of the first embodiment.

FIG. 10 is a view relating to the fifth embodiment of the present invention, and is a flowchart showing a flow in which a process control is not applied to a plasma treatment process at the time of starting up the production of a semiconductor device and the process control is applied after the start of the production.

In FIG. 10, the manufacture of the semiconductor device is performed by a treatment process/inspection process S091 prior to the plasma treatment process and a plasma treatment process S092 performed without the process control (using no process control). The production of the semiconductor device is continued as it is, and the inspection data of the process prior to the plasma treatment is stored in a database 91 and the inspection data obtained in the inspection process S093 after the plasma treatment is stored in a database 92. It does not matter if the database 91 and the database 92 are the same database. When it is determined that automatic optimization is possible in an automatic optimization condition determination step S094, an automatic optimization step S095 of the prediction model coefficient is executed, and prediction model coefficients (b₁ to b₅) and a feedback coefficient such as an EWMA coefficient (γ) are automatically optimized. Since the parameter necessary for the process control can be obtained by the step S095, next, a plasma treatment process S096 using the process control is started.

In order to perform the automatic optimization in the step S095 when the process control is not performed, a virtual control value y_{c}⁽ⁿ⁾ defined by the following formula 10 is used.

y_{C}⁽ⁿ⁾=y⁽ⁿ⁾−(yₑ⁽ⁿ⁾−y₀) [Formula 10]

By using the virtual control value of the formula 10, the control shift amount evaluation function E_{FB} is defined by, for example, the following formula 11.

$${E}_{FB} ( {b}_{1} , {b}_{2} , {b}_{3} , {b}_{4} , {b}_{5} , γ ) = {\sum }_{n} ( {y}_{C}^{( n )} - {y}_{0} ) \qquad [ Formula 11 ]$$

When the prediction model coefficients b₁ to b₅ and γ which minimize the control shift amount evaluation function E_{FB} defined by the formula 11 are determined, they become the optimum prediction model coefficients and feedback coefficients.

As described above, according to the manufacturing system and the manufacturing method of the semiconductor device of the fifth embodiment, when a process control is not applied to a plasma treatment process at the time of starting up the production of a semiconductor device and the process control is applied after the start of the production, the same effects as the first and second embodiments can be obtained.

### Sixth Embodiment

The manufacturing system and the manufacturing method of a semiconductor device according to the sixth embodiment of the present invention will be described.

In the sixth embodiment, it is assumed that a certain i-th manufacturing process performs the production by a plurality of manufacturing apparatuses, and each wafer passes through any one of the plurality of manufacturing apparatuses to receive the i-th processing treatment. Such a production system is frequently employed in the work site of the semiconductor manufacture. The value of the prediction model coefficient bᵢ corresponding to the i-th manufacturing process sometimes depends on the manufacturing apparatus itself used in this manufacturing process. The manufacturing process in this state is referred to as “the manufacturing process having a path dependency”. The prediction model coefficient corresponding to the manufacturing process having the path dependency is required to have an index representing the manufacturing apparatus used in this manufacturing process as an argument, and a processing shape prediction model formula becomes as the following formula 12.

$${y}_{e}^{( n )} = {y}_{0} + {\sum }_{i = 1}^{M} ( {b}_{i} ( {k}_{i} ) ( {x}_{i}^{( n )} - {X}_{i} ) ) \qquad [ Formula 12 ]$$

In the formula 12, yₑ⁽ⁿ⁾ is a prediction value of the processing shape, y₀ is a target value of the processing shape, M is the number of manufacturing processes used for the processing shape prediction, kᵢ is the number representing the individual of the manufacturing apparatus used in the i-th process, bᵢ(kᵢ) is a processing shape prediction model coefficient corresponding to the case where the i-th manufacturing process is applied to the processing treatment by the kᵢ-th manufacturing apparatus, xᵢ⁽ⁿ⁾ is a shape data inspected after the i-th manufacturing process of the n-th wafer, and Xᵢ is a target value of the shape data of this inspection process. Although the procedure for the automatic optimization of the prediction model coefficient is performed in the same manner as FIG. 3 of the first embodiment, the wafer used for the automatic optimization calculation of the prediction model coefficient bᵢ(kᵢ) in the formula 4 is limited to the wafer subjected to the processing treatment in the kᵢ-th manufacturing apparatus.

As described above, according to the manufacturing system and the manufacturing method of the semiconductor device of the sixth embodiment, when a process control is applied not only to the plasma treatment process but also to the manufacturing process when a certain i-th manufacturing process performs the production by a plurality of manufacturing apparatuses, the same effects as the first and second embodiments can be obtained.

In the foregoing, the invention made by the inventors of the present invention has been concretely described based on the embodiments. However, it is needless to say that the present invention is not limited to the foregoing embodiments and various modifications and alterations can be made within the scope of the present invention.

The manufacturing system and the manufacturing method of a semiconductor device according to the present invention can be widely applied not only to the manufacturing system and the manufacturing method of a semiconductor device using the plasma treatment apparatus, but also to the process control of the processing treatment using plasma.

What is claimed is:

1. A manufacturing system of a semiconductor device, comprising:
a plasma treatment apparatus for plasma-treating a wafer to be treated; and
a control unit for controlling a treatment condition of the plasma treatment apparatus,
wherein the control unit is a device for controlling the treatment condition of the plasma treatment apparatus so that a desired shape is obtained after the treatment by the plasma treatment apparatus by using a prediction model for calculating a shape after the treatment by the plasma treatment apparatus from inspection data of the wafer prior to the treatment and a response surface model for calculating a processing shape depending on the treatment condition of the plasma treatment apparatus,
the prediction model includes a prediction model coefficient representing a degree of influence of each variable used for this prediction model, and
the prediction model coefficient is calibrated by the control unit.

2. The manufacturing system of a semiconductor device according to claim 1,
wherein an optimum value of the prediction model coefficient is obtained by using a control shift amount evaluation function for evaluating a shift amount from a target value of a treatment result by the plasma treatment apparatus.

3. The manufacturing system of a semiconductor device according to claim 2,
wherein a function in consideration of a feedback correction amount of the response surface model is used as the control shift amount evaluation function.

4. The manufacturing system of a semiconductor device according to claim 1,
wherein the prediction model coefficient is not determined by an experiment and a predetermined value is given as an initial value of the prediction model coefficient, and the prediction model coefficient is optimized while continuing the manufacture of the semiconductor device.

5. The manufacturing system of a semiconductor device according to claim 2,
wherein the prediction model coefficient is not determined by an experiment and a predetermined value is given as an initial value of the prediction model coefficient, and the prediction model coefficient is optimized while continuing the manufacture of the semiconductor device.

6. The manufacturing system of a semiconductor device according to claim 3,
wherein the prediction model coefficient is not determined by an experiment and a predetermined value is given as an initial value of the prediction model coefficient, and the prediction model coefficient is optimized while continuing the manufacture of the semiconductor device.

7. The manufacturing system of a semiconductor device according to claim 1,
wherein a plurality of the semiconductor devices are manufactured, and
the prediction model coefficient used for a first semiconductor device is given as an initial value of the prediction model coefficient for a second semiconductor device, and the prediction model coefficient is optimized while continuing the manufacture of the plurality of semiconductor devices.

8. The manufacturing system of a semiconductor device according to claim 2,
wherein a plurality of the semiconductor devices are manufactured, and
the prediction model coefficient used for a first semiconductor device is given as an initial value of the prediction model coefficient for a second semiconductor device, and the prediction model coefficient is optimized while continuing the manufacture of the plurality of semiconductor devices.

9. The manufacturing system of a semiconductor device according to claim 3,
wherein a plurality of the semiconductor devices are manufactured, and
the prediction model coefficient used for a first semiconductor device is given as an initial value of the prediction model coefficient for a second semiconductor device, and the prediction model coefficient is optimized while continuing the manufacture of the plurality of semiconductor devices.

10. The manufacturing system of a semiconductor device according to claim 1,
wherein, in the manufacture of the semiconductor device, the treatment by the plasma treatment apparatus is started in a state having no control by the control unit, and the prediction model coefficient is optimized when a specific condition is satisfied, and then, the treatment by the plasma treatment apparatus is started while being controlled by the control unit.

11. The manufacturing system of a semiconductor device according to claim 2,
wherein, in the manufacture of the semiconductor device, the treatment by the plasma treatment apparatus is started in a state having no control by the control unit, and the prediction model coefficient is optimized when a specific condition is satisfied, and then, the treatment by the plasma treatment apparatus is started while being controlled by the control unit.

12. The manufacturing system of a semiconductor device according to claim 3,
wherein, in the manufacture of the semiconductor device, the treatment by the plasma treatment apparatus is started in a state having no control by the control unit, and the prediction model coefficient is optimized when a specific condition is satisfied, and then, the treatment by the plasma treatment apparatus is started while being controlled by the control unit.

13. A manufacturing method of a semiconductor device,
wherein the semiconductor device is manufactured by using the manufacturing system of a semiconductor device according to claim 1.
